(19) United States
(12) Patent Application Publication
(10) Pub. No.: US 2004/0005080 A1
(43) Pub. Date: Jan. 8, 2004

(54) Method and apparatus for processing outgoing bulk mail

(76) Inventor: George L. Hayduchok, Mount Holly, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/190,981

(22) Filed: Jul. 8, 2002

(51) Int. Cl. G06K 9/00

(52) U.S. Cl. 382/101

(57) ABSTRACT

A method and apparatus for processing mail is provided. The mail is serially fed from a stack of mail into a system transport. The system transport conveys the mail to a reader, which scans the mail to obtain image data corresponding to at least a portion of each piece. The image data is analyzed by a plurality of optical character readers. The data from the optical character readers is communicated with an address processing module, which attempts to validate that the data from the optical character readers is an actual address. The character data from the various readers can be selected so that data from different readers is combined to create a combined data set that is analyzed by the address processing module.

### FIELD OF THE INVENTION

The present invention relates to the field of processing bulk mail. More specifically, the present invention relates to a method and apparatus for scanning pieces of mail and determining the addresses for the pieces of mail.

### BACKGROUND

Processing outgoing mail includes several steps, many of which are frequently done manually. This is particularly true when processing mixed mail, such as mail including standard envelopes, various-sized parcels, catalogs, etc. The proper postage for each piece depends on the weight of the piece, and may also depend on the recipient's address. Accordingly, to prepare a piece for the outgoing mail, an operator weighs the piece, and checks the zipcode in the recipient's address. Depending on the weight and zipcode, the operator determines the necessary postage, and prepares a postage label, which the operator adheres to the package. The piece may then be sorted according to zipcode. The number of manual steps involved in such processing reduces the efficiency of preparing the outgoing mail, which increases the overall cost of mailing items.

### SUMMARY OF THE INVENTION

In light of the foregoing, the present invention provides an improved method and apparatus for the automated processing of bulk mail. In one embodiment, an apparatus is provided, which comprises a system transport for conveying mail on a transport path. A scale positioned along the transport path is provided for weighing the pieces of mail. An imaging station position along the transport path scans the pieces of mail to obtain image data for the mail to determine the address of the recipients of the pieces of mail. A labeler position along the transport path applies labels to the mail. The apparatus also includes a processor operable to determine the postage required for a piece of mail in response to the weight of the piece of mail. In addition, a printer is provided that is operable to print the determined postage onto a postage label for the piece.

Another aspect of the invention provides an apparatus for processing mail comprising a feeder for serially feeding mail from a stack of mail. The apparatus includes a conveyor confronting the stack of mail, which is operable to convey the stack of mail toward the feeder. A pusher confronting the stack of mail is operable to support the stack of mail and urge the stack of mail toward the feeder. A controller independently controls the conveyor and the pusher, preferably to maintain the angle between the mail and the feeder within a predetermined range.

Yet another aspect of the invention provides an apparatus for processing pieces of mail having mailing information, comprising a scanner operable to scan a piece of mail to obtain image data corresponding to the mailing information for the piece. A first OCR module is operable to receive and process the image data to create a first set of character data for the piece of mail. A second OCR module is operable to receive and process the image data to create a second set of character data for the piece of mail. An address processing module is in operative communication with the first and second OCR modules and is operable to receive and process the character data from the first and second character data sets and compare the character data with the address information in the database to identify address information corresponding to the mailing information on the piece of mail.

A still further aspect of the present invention provides an alternate apparatus for processing pieces of mail having mailing information, comprising a scanner operable to scan a piece of mail to obtain image data corresponding to the mailing information for the piece. A first OCR module is operable to receive and process the image data to create a first set of character data for the piece of mail. A second OCR module is operable to receive and process the image data to create a second set of character data for the piece of mail. The apparatus includes a zip code assignment module that is operable to select character data from the first and second character data sets, and analyze the select data to identify address information for the piece of mail.

The present invention also provides several methods for processing mail. For instance, one method comprises the steps of scanning a piece of mail to determine the recipient and weighing the piece to determine its weight. The appropriate postage is then determined based on the determined weight of the piece. The appropriate postage is printed on a label and the label is then adhered onto the piece.

Another method for processing mail comprises serially feeding mail with a feeder. A stack of mail is conveyed toward the feeder, and the angle that the mail forms with a feeder as the mail engages the feeder is monitored. The manner in which the stack of mail is conveyed toward the feeder is then controlled to maintain the angle that the mail forms with the feeder within a predetermined range.

Yet another method relates to identifying the address for a piece of mail. A piece of mail is scanned to obtain image data corresponding to the mailing information. The image data is analyzed using a first OCR module to obtain a first set of character data. The image data is also analyzed using a second OCR module to obtain a second set of character data. The data from the first and second sets of character data are compared and data is selected from the first or second sets of character data in response to the comparison. The selected data is that analyzed to identify address information for the piece of mail.

A still further method relates to an alternate method for identifying the address for a piece of mail. A piece of mail is scanned to obtain image data corresponding to the mailing information. The image data is analyzed using a first OCR module to obtain a first set of character data. The image data is also analyzed using a second OCR module to obtain a second set of character data. The first and second character data sets are processed using an address processing module having a database of address information. The step of processing comprises communicating the character data from the first and second sets of character data with the address processing module. The character data is compared with the address information in the address processing module to identify address information corresponding to the mailing information on the piece of mail

### DESCRIPTION OF THE DRAWINGS

The foregoing summary as well as the following detailed description of the preferred embodiments will be best understood when read in conjunction with the following drawings, in which:

FIG. 1 is a front perspective view of an apparatus for processing bulk mail;

FIG. 2 is a rear perspective view of the apparatus illustrated in FIG. 1;

FIG. 3 is an enlarged fragmentary perspective view of the apparatus illustrated in FIG. 2;

FIG. 4 is an enlarged fragmentary side elevational view of the apparatus illustrated in FIG. 1;

FIG. 5 is an enlarged fragmentary rear perspective view, partially broken away, of a portion of the feeder of the apparatus illustrated in FIG. 1;

FIG. 6 is an enlarged fragmentary front perspective view, partially broken away, of a portion of the feeder of the apparatus illustrated in FIG. 1;

FIG. 6A is an enlarged fragmentary front perspective view of a portion of the feeder illustrated in FIG. 6;

FIG. 7 is an enlarged front perspective view of a stacker unit of the apparatus illustrated in FIG. 1;

FIG. 8 is a rear perspective view of the stacker unit illustrated in FIG. 7;

FIG. 9 is a block diagram illustrating the interconnection between elements of the apparatus illustrated in FIG. 1; and

FIG. 10 is a block diagram illustrating the interconnection between an imaging computer and other elements in the apparatus illustrated in FIG. 1.

### DETAILED DESCRIPTION

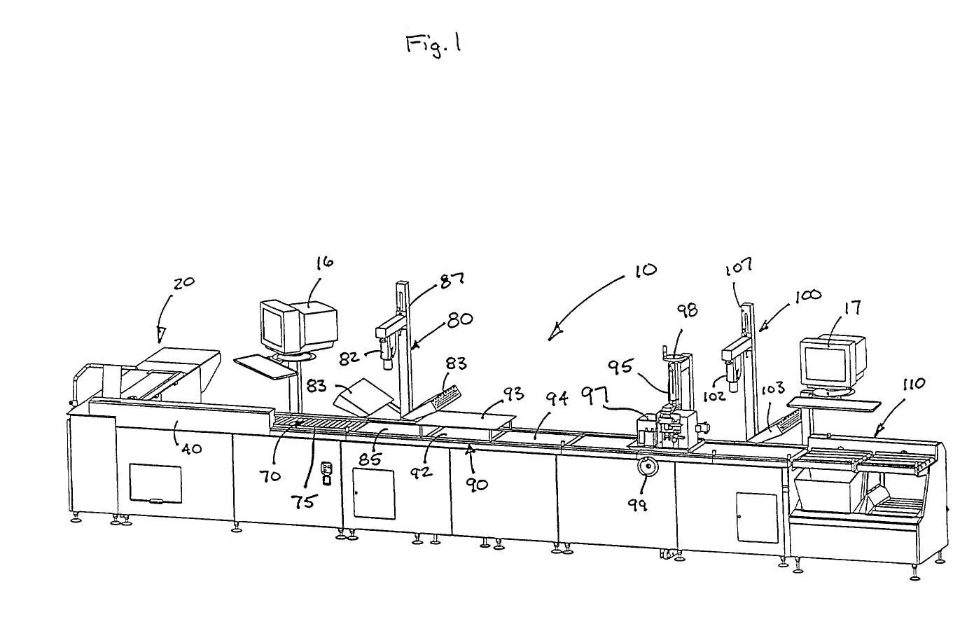

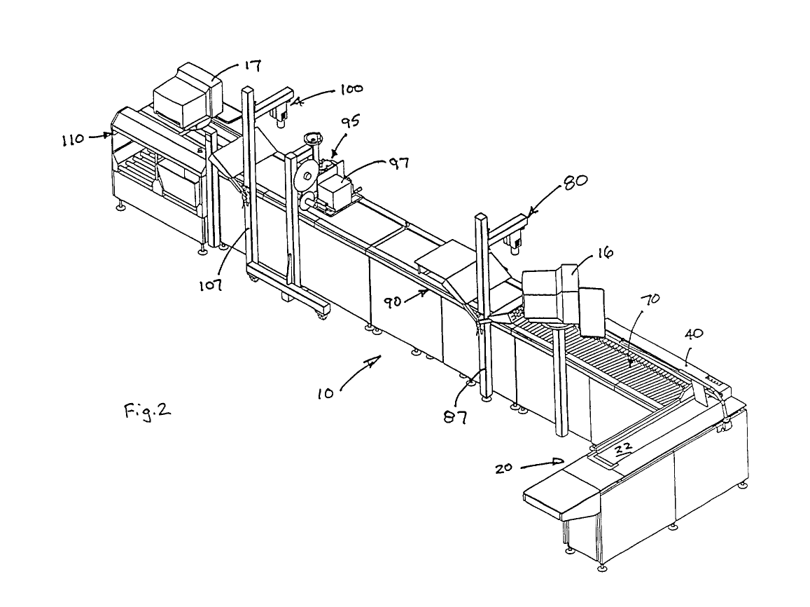

Referring to the drawings in general and to FIGS. 1 and 2 specifically, an apparatus for processing mail is designated 10. The apparatus 10 is particularly suited to prepare outgoing mixed mail 5, including items such as parcels, catalogs, envelopes and other types of items. The apparatus 10 scans each piece of mail 5 to determine the recipient's address, then weighs each piece and applies a label with the appropriate postage. The mail 5 is then sorted into a plurality of bins.

Brief Overview

To process a batch of mail 5, the batch is placed into the feeding station 20 to form a stack of mail. The stack of mail 5 rests on a conveyor 22, which displaces the stack toward a feeder 40. A movable pusher 30 supports the rearward end of the stack of mail. The pusher 30 moves toward the feeder 40 to displace the stack of mail 5 toward the feeder. The feeder 40 serially feeds the mail from the stack onto a roller bed 70, which conveys the mail to a reader 80. Each piece of mail is pre-printed with the recipient's address. The reader 80 scans each piece to read the recipient's address. From the reader 80, the mail is transported to a scale 90, which weighs each piece.

After being scanned and weighed, each piece is transported to a labeler 85, which applies the appropriate postage to each piece of mail. The mail is then conveyed to a sorting station 110, which sorts the mail into a plurality of bins 115,116. Prior to sorting the mail, it may be desirable to verify that the proper postage was applied to the mail. Accordingly, a verifier 100 may be included to scan in the mail to read the recipient's address and the applied postage. If the scanned address and applied postage are correct, the piece is sorted into the outgoing mail in the sorting station 110. Otherwise, the mail is sent to a reject bin.

A system controller 15 monitors and controls the flow of mail through the apparatus 10 in response to signals received from sensors at various points along the transport path. A system computer 16 allows an operator to interface with the system controller 15 to control the operation of the apparatus 10. The system computer includes a monitor to display information regarding the processing of the mail. A keyboard is also provided to allow the operator to input various information necessary to process a group of mail, such as the type of mail in a batch to be processed. Preferably, the system computer 16 also processes the image data obtained by the reader 80. A separate computer 17 may also be provided for receiving the image data and performing optical character recognition as described further below. In addition, a separate verifier computer 18 may be provided for processing image data obtained by the verifier 100.

The details of the various components of the apparatus 10 will now be described in greater detail.

Feeding Station

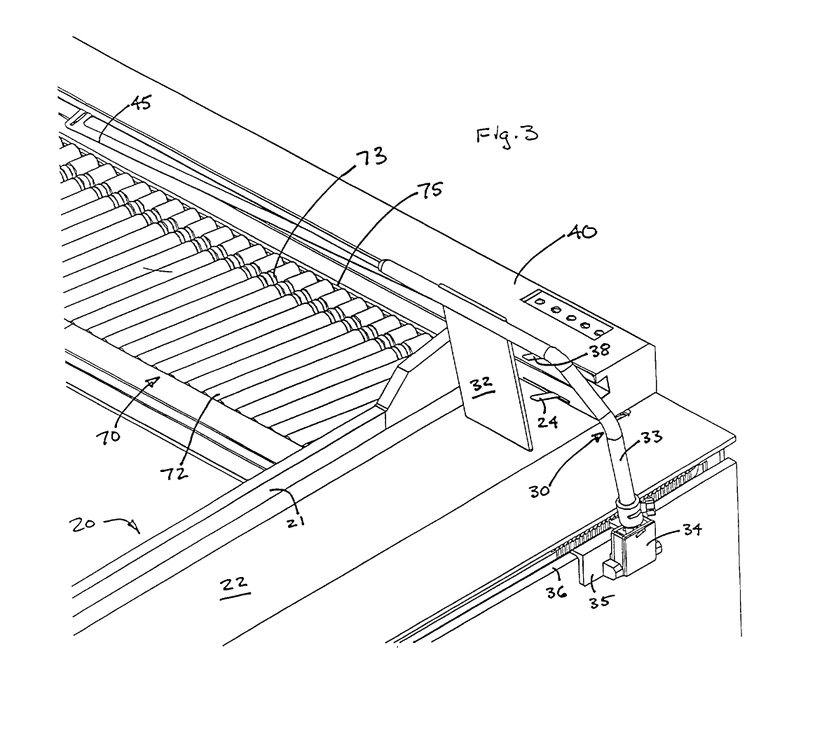

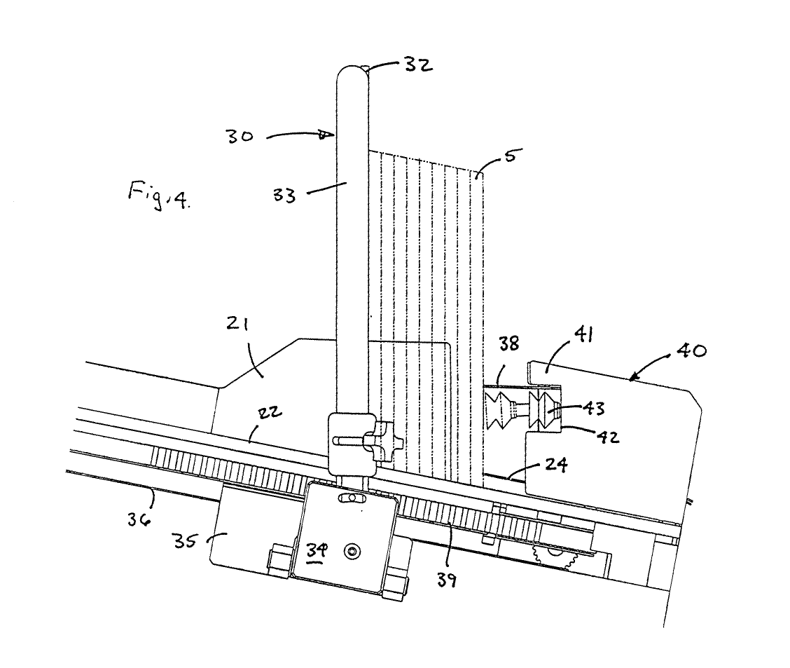

Referring now to FIGS. 3 and 4, the details of the feeding station 20 are shown in greater detail. To begin processing a batch of mail 5, an operator places the stack of mail on a feeder conveyor 22 located in the feeding station 20. The conveyor 22 moves the mail toward a feeder 40, which feeds the mail one-piece at a time from the stack. The conveyor 22 comprises a conveyor belt that is carried on a pair of pulleys, which are driven by a conveyor motor 27.

The stack of mail 5 is manually loaded onto the conveyor 22 on edge with the flat surface of the pieces of mail oriented in a generally vertical orientation. In other words, the stack 5 is positioned on the conveyor so that the bottom edges of the mail rests upon the conveyor belt 22. In addition, preferably the stack is placed up against a sidewall 21 that extends along the length of the conveyor.

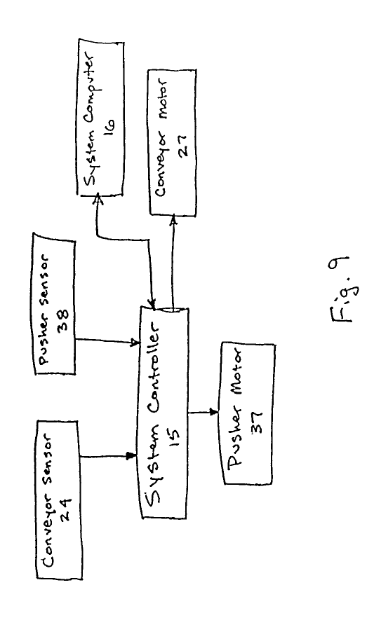

Preferably, the conveyor motor 27 (shown in FIG. 9) is a stepper motor, and the system controller 15 controls the operation of the conveyor motor, thereby controlling the displacement of the mail 5 toward the feeder 40. Preferably, the conveyor is selectively controlled in response to a feed sensor 24, as discussed further below.

As shown in FIG. 4, there is a gap between the side wall 21 of the feeding station 20 and the feeder 40. The feeder 40 feeds the mail through this gap. The conveyor feed sensor 24 comprises an arm that projects into the gap. The conveyor 22 moves the stack of mail 5 into the gap, so that the mail engages the conveyor feed sensor 24, displacing the sensor arm inwardly toward the feeder.

The sensor 24 essentially operates as an on/off switch. When the lead piece of mail engages the sensor arm and displaces the arm inwardly to a pre-set trigger position in the gap, the conveyor is stopped. Specifically, when the sensor arm is displaced inwardly to the trigger position, the sensor 24 sends a signal to the system controller 15, which stops the conveyor motor 27, thereby stopping the conveyor 22. The sensor arm is biased outwardly, so that after the feeder 40 feeds the lead piece of mail from the stack 5, the sensor arm is automatically displaced outwardly toward the second piece of mail in the stack, which is the new lead piece of mail in the stack. When the sensor arm is displaced outwardly, the sensor sends a signal to the system controller 15, which starts the conveyor motor 27, thereby starting the conveyor 22.

The rearward end of the stack of mail on the conveyor 22 is supported by a pusher 30. The pusher 30 comprises a plate 32 that is positioned at an angle that permits the stack of mail 15 to lay back on the plate as the stack is conveyed toward the feeder 40. The pusher plate 32 is supported by a generally L-shaped arm 33, having a horizontal leg that projects over the conveyor 22. Preferably, the plate 32 is fixedly attached to the pusher arm 33 so that the lower edge of the plate is vertically separated from the conveyor 22, thereby forming a gap between the pusher plate and the conveyor.

The support arm 33 also includes a vertical leg, which is pivotably attached to a mounting block 34. In this way, the angle of the pusher plate, relative to the conveyor 22, can be varied manually. The mounting block engages a timing belt 39 to drive the pusher 30 forwardly. More specifically, the mounting block 34 comprises a bracket 35 that operates as a sled, which rides on a rail 36 to guide the pusher 30. A tongue attached to the mounting block 34 projects into engagement with the teeth of the timing belt 39.

The mounting block 34 and attached sled 35 can be pulled outwardly, away from the rail 36 to disengaged the pusher 30 from the timing belt 39. The pusher 30 can then be manually displaced along the rail to re-position the pusher relative to the conveyor 22. For instance, when the feeder 40 finishes feeding a stack of mail, the pusher is at the end of the conveyor 22, adjacent the feeder 40. The pusher 30 can be disengaged from the timing belt 39 and slid rearwardly to support a new stack of mail.

As mentioned above, the timing belt 39 drives the pusher 30 forwardly toward the feeder 40. The feed rate of the pusher 30 can be matched to the conveyor 22 so that the pusher and the conveyor feed the mail together at the same rate. For instance, the timing belt 39 may be interconnected with the conveyor motor 27 so that the motor drives both the pusher and the conveyor. Alternatively, and preferably, the pusher 30 is driven by a separate motor 37 (see FIG. 9) that is controlled independently of the conveyor motor 22. More specifically, preferably the pusher 30 operates in response to a pusher feed sensor 38 that is configured similarly to the conveyor feed sensor 24 described above.

As shown in FIG. 4, the pusher feed sensor 38 projects from the feeder 40, toward the stack of mail 5. The pusher feed sensor 38 is vertically separated from the conveyor feed sensor 24. In this way, the conveyor and pusher can be controlled independently to control the angle of the mail as it is displaced toward the feeder.

For instance, as shown in FIG. 4, it is desirable to feed the mail so that the mail is tilted back against the pusher, rather than being maintained upright (i.e. perpendicular to the conveyor). If the stack of mail is disposed at the desired feed angle, the stack of mail simultaneously displaces the pusher feed sensor 38 and conveyor feed sensor 24 past the trigger point for each sensor. If the stack of mail becomes more upright than desired, the lead piece of mail displaces the pusher feeds sensor 38 inwardly past the trigger point, but not the conveyor feed sensor 24. In response, the controller starts the conveyor 22 to drive the lower edge of the stack forwardly until the desired feed angle is obtained for the stack of mail. Conversely, if the stack of mail is tilted over too far, the lead piece of mail displaces the conveyor feed sensor 24 past the trigger point, but not the pusher feed sensor 38. In response, the controller starts the pusher motor 37 to drive the pusher 30 forward until the desired feed angle is obtained for the stack of mail.

In other words, the system controller 15 monitors the horizontal position of the lead piece of mail 5 in the stack at two vertically separated points. By doing so, the controller 15 can independently control the pusher 30 and the conveyor 22 to vary the feed angle of the stack of mail.

As described above, the system controller 15 independently controls the conveyor 22 and the pusher 30 to maintain the feed angle of the lead piece of mail within a desired range. In addition, the system controller controls the conveyor 22 and the pusher 30 to maintain the lead piece of mail and a desired position spaced apart from the feeder 40. More specifically, the pusher 30 and the conveyor 22 are operable to displace the lead piece of mail toward the feeder 40, thereby altering the distance between the front face of the lead piece of mail and the feeder. The system controller 15 controls the conveyor 22 and pusher 30 in response to signals from sensors 24, 38 to maintain the proper gap or spacing between the lead piece of mail and the suction cup of the feeder 40.

Feed sensors 24, 38 have been described as trigger-type sensors or on/off sensors. In response to the sensors, the pusher 30 and the conveyor 22 are either on or off. In other words, the speed of the pusher and the conveyor do not vary depending on the relative position of the sensors. They are in either running at a pre-set speed or off.

In an alternate arrangements, the feed sensors are position sensing sensors, rather than trigger sensors. A position sensing sensor, such as a linear variable differential transducer (LVDT) or potentiometer, indicates the relative position of the sensor arm so that the system controller can monitor the speed of the appropriate element (i.e. pusher or conveyor).

If position sensing sensors are used, there is still a trigger point at which the system controller stops the appropriate element. However, as the sensor arm moves outwardly away from the trigger point, the system controller starts the appropriate element, and speeds it up as the sensor arm moves further outwardly.

By way of example, referring to FIG. 4, the pusher feed sensor 38 is illustrated at its trigger point, with the lead piece of mail at the appropriate position and feed angle. Therefore, the sensor sends a signal to the system controller 15, which stops the pusher motor 37. When the feeder feeds the lead piece of mail, the arm of the sensor 38 will move outwardly. If the piece is a thin piece, the sensor arm will only move outwardly slightly, so that the system controller will start the pusher 37, but it will operate at a relatively low speed. In contrast, if the lead piece is a thick piece, such as a parcel, the sensor arm will move further outwardly, so that the pusher speeds up to push the new lead piece forward quickly to fill the gap created when the parcel was fed. The conveyor sensor 24 operates substantially similarly.

In addition, when using a position sensing sensor, it may be desirable to use reversible motors for the conveyor motor 27 and the pusher motor 37. In this way, if one of the sensors 24, 38 is displaced inwardly beyond the trigger point, the appropriate motor could be reversed to correct the position of the lead piece of mail. For instance, if the stack of mail slides forward, the conveyor sensor 24 will be displaced inwardly toward the feeder beyond the trigger point. If the sensor is a position sensing sensor, it can detect how far inwardly the mail has pushed the sensor arm beyond the trigger point. In response, the system controller 15 drives the conveyor rearwardly to straighten up the stack.

Feeder

The feeder 40 feeds the mail one-piece at time from the stack of mail in the feeding station 20. The feeder has a suction cup 43 that pivots toward the mail 5 to engage the lead piece of mail and then pulls the piece away from the stack of mail. The feeder then displaces the piece of mail from the stack to the roller bed conveyor 70. It then releases the piece so that the piece drops onto the roller bed. When the mail drops onto the roller bed 70 it falls over so that the front face of the piece of mail faces upwardly.

Turning now to FIGS. 3-6, the feeder will be described in greater detail. The feeder 40 comprises a collapsible suction cup 43 connected to a vacuum source. The suction cup 43 is attached to an arm 44 that is pivotable toward and away from the mail 5, and is laterally displaceable transverse the direction of the conveyor 22.

The feeder 40 comprises a face plate 41 that extends along the length of the feeder. The face plate 41 includes a recess or channel 42 extending along the face plate. The channel 42 is configured to receive the suction cup 43 so that the suction cup can be withdrawn into the channel during use. The feeder arm 44 is generally L-shaped, having an elongated leg disposed behind the face plate 41, and a short leg projecting through an elongated slot in the channel 42.

The feeder arm is attached to a carriage 50 that rides along a rail 52 when the feeder arm translates the suction cup 43 from the conveyor 22 to the roller bed 70. A vacuum line 46 attached to the carriage 50 provides a vacuum for the suction cup 43. A guard 48 formed of a plurality of pivotably interconnected links shields the vacuum line 46 and limits the displacement of the vacuum line during use.

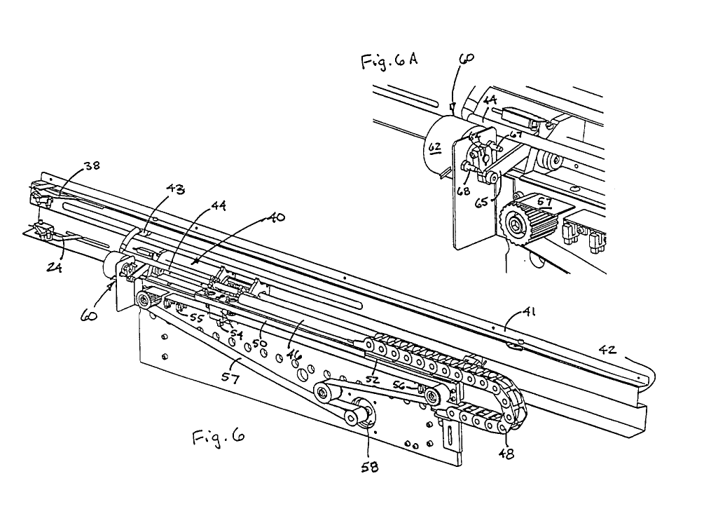

As discussed previously, the feeder arm 44 is displaceable in two directions: the first direction is the motion of the arm pivoting toward and away from the face plate 41; the second direction is the translation of the arm along the face plate. The pivoting motion of the arm 44 is best understood in connection with FIGS. 4, 6 and 6A. The feeder arm 44 is pivotable between a first position and a second position, as shown in FIG. 4. In the first position, the suction cup 43 is disposed within the recess 42 of the face plate. The arm pivots outwardly toward a second position (shown in phantom) to engage the lead piece of mail on the conveyor 22. In the second position, the vacuum force of the suction cup 43 pulls the piece toward the suction cup. Since the suction cup is bellows-shaped, the suction cup collapses when the piece engages the suction cup.

After the suction cup 43 engages the lead piece of mail, the feeder arm 44 reverse pivots back toward the face plate 41. More specifically, the arm pivots away from the stack of mail in a plane parallel to the direction of the feed conveyor 22. The feed arm 44 and suction cup 43 may be configured so that the arm simply pivots back to the first position to pull the piece of mail away from the stack of mail. However, since the suction cup is preferably bellows-shaped and collapsible, preferably the arm pivots to a third position between the first and second positions. In the third position, the suction cup 43 is positioned within the channel 42 so that the face of the suction cup is substantially aligned with the front face of the face plate when the suction cup is collapsed. In this way, in the third position, the suction cup 43 pulls the piece of mail up against the face plate 41.

As previously described, the system controller 15 controls the position of the lead piece of mail relative to the feeder 40, to improve the feeding of the mail. Specifically, the lead piece is positioned at a point so that the lip of the uncollapsed suction cup 43 can engage the lead piece of mail, as shown in FIG. 4. Preferably, the outer rim or lip of the suction cup forms an angle with the front face of the piece of mail.

The feeder entrains the lead piece of mail as follows. The feeder arm 44 pivots the suction cup 43 outwardly toward the second position. As the suction cup 43 approaches the lead piece of mail, the vacuum force in the suction cup is ordinarily sufficiently strong to pull the lead piece of mail toward the suction cup. Therefore, for most of the mail, the lead piece of mail is sucked into engagement with the suction cup 43 before the feeder arm reaches the second position. The suction cup 43 then collapses when it engages the lead piece. Since the lead piece is typically pulled toward the suction cup, which then collapses, there is a gap between the lead piece and the second piece of mail when the suction cup is displaced into the second position. This gap reduces the likelihood that the vacuum force will bleed through the lead piece sufficiently to entrain the second piece, which would cause a double feed.

If the lead piece is heavier, the feeding is slightly different. The suction cup 43 may not have sufficient vacuum force to pull the piece toward the suction cup before the suction cup reaches the second position. However, the lead piece is positioned so that the uncollapsed suction cup either directly engages the lead piece or there is a little gap between the lead piece and the suction cup. Therefore, in the second position, substantially all of the vacuum force of the suction cup is applied to the lead piece, which is sufficient vacuum force to engage the lead piece. Since the lead piece is heavier, it is unlikely that the vacuum force will bleed through the lead piece and engage the second piece even though there is no gap between the lead piece and the second piece when the suction cup is displaced into the second position.

Referring now to FIGS. 6 and 6A, the linkage 60 controlling the pivoting of the feed arm 44 is illustrated. The linkage comprises a crank arm 64 connected to a three-position rotary solenoid 62. A connecting link 65 is pivotably connected to the crank arm 64 and the connecting link is attached to a plate, which in turn is in contact with the feed arm 44. Springs bias the feed arm 44 downwardly toward the first position described above. When the solenoid 62 drives the crank arm 64 forwardly, the connecting link 64 raises upwardly, thereby lifting the attached plate, which pivots the feed arm 44 outwardly. Conversely, when the solenoid 62 drives the crank arm 64 in a reverse direction, the connecting arm 65 lowers the attached plate, allowing the biased feed arm 44 to move downwardly, which pivots the feed arm inwardly. In this way, the linkage 60 is operable to pivot the feed arm 44 inwardly or outwardly when the feed arm is adjacent the feeding station 20 or the roller bed 70, or at any point between the two.

As shown in FIG. 6A, preferably, the linkage includes a forward stop 67 and a rearward stop 68, which limit the range that the crank arm 64 can pivot. This in turn limits the range that the feed arm 44 can pivot.

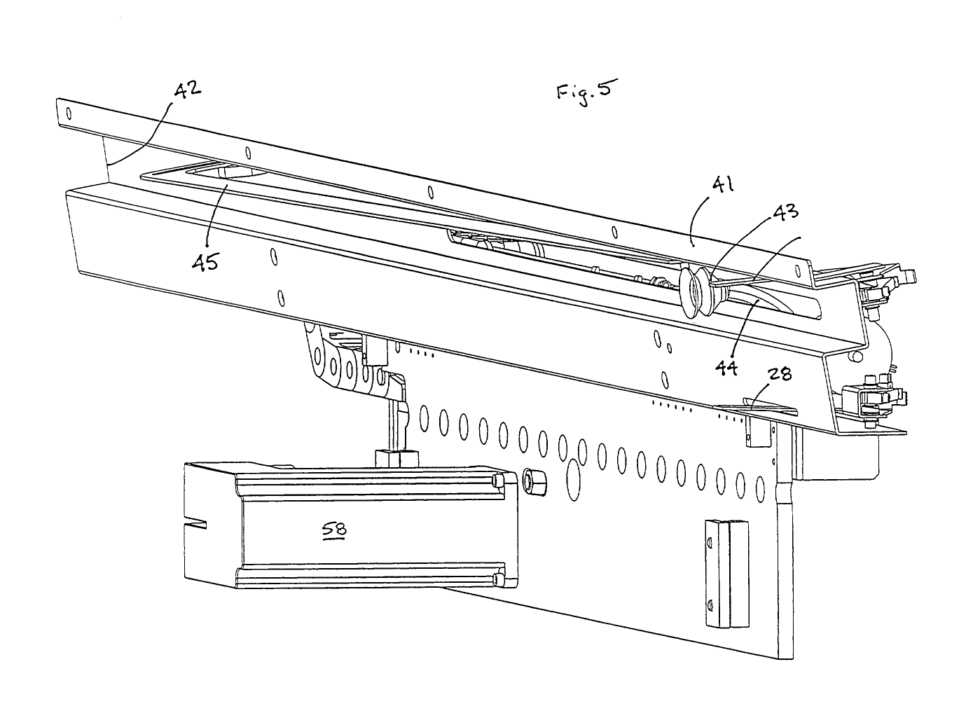

After the feed arm 44 reverse pivots and pulls a piece of mail up against the face plate 41, the feed arm then translates longitudinally along the face plate 41, transporting the piece from the feed conveyor 22 to the roller bed 70. Referring to FIGS. 5 and 6, the details of this translation motion will now be described in detail.

As previously mentioned, the feed arm 44 is attached to a carriage 50 that rides on a guide rail 52. A drive belt 57 drives the carriage 50 along the guide rail 52. A pair of connecting blocks 54 attach the drive belt 57 to the carriage 50. More specifically, the connecting blocks 54 are fixedly attached to the carriage 50, and the drive belt 57 is sandwiched between the connecting blocks, so that the connecting blocks are fixedly attached to the belt at a point along the length of the belt.

A reversible motor 58 drives the drive belt 57. In a forward direction, the motor 58 drives the belt 57 clockwise, which displaces the feed arm 44 from the feeding station 20 to the roller bed 70. In a reverse direction, the motor 58 drives the belt 57 counter-clockwise, which displaces the feed arm 44 from the roller bed 70 back to the feeding station 20.

A tongue projecting from the connecting blocks 54 operates in connection with sensors to indicate the position of the carriage 50, which in turn indicates the position of the feeder arm 44. Specifically, when the carriage 50 is disposed forward, the tongue blocks a home sensor 55, which sends a signal to the system controller indicating that the feeder arm 44 is in the home position, with the suction cup 43 adjacent the stack of mail 5. When the carriage is displaced toward the roller bed 70, the tongue on the connecting blocks 54 blocks a midway sensor 56, which sends a signal to the system controller 15 indicating that the feed arm is moving toward the roller bed. After the tongue passes the midway sensor 56, the feeder motor 58 drives the carriage rearwardly at a constant speed for a pre-set time so that the feeder arm 44 and entrained piece of mail are adjacent the roller bed.

As described above, the feed arm 44 pivots to pull a piece of mail 5 away from the stack and then translates away from the stack to feed the piece onto the roller bed 70. Preferably, the length, or stroke, of the translation is at least as long as the piece of mail. In this way, the feed arm 44 engages the piece of mail, pulling the entire length of the piece away from the stack of mail before releasing the piece so that it drops onto the roller bed 70.

Referring now to FIG. 5, the face plate 41 comprises upper and lower surfaces separated by the channel 42. The upper and lower surfaces are substantially planar so that the piece of mail can readily slide along the face plate as it is conveyed toward the roller bed 70. In addition, preferably the roller bed is configured to facilitate the piece of mail dropping down onto the roller bed, rather than standing on edge up against the face plate when the feeder 40 releases the piece. Several features allow this. First, preferably the feeder 40 comprises a kicker bar 45 that urges the mail away from the feeder. The kicker bar 45 is disposed at an angle relative to the surface of the face plate, so that the piece of mail rides up the kicker 45 like a ramp as the piece of mail is displaced along the face plate 41. As can be seen in FIGS. 3, 5 and 6, the kicker 45 is pivotable so that the angle of the kicker can be changed depending on the mail being processed. In addition, preferably the bottom edge of the face plate 41 is disposed above the roller bed 70, providing a gap. This gap can be formed by either positioning the face plate 41 above the roller bed or by providing a recess along the lower edge of the face plate. Either way, this gap allows the mail to more readily fall away from the feeder 40 onto the roller bed 70, since the bottom edge of the mail can slide inwardly into the gap. Finally, preferably the surface of the face plate 41 forms an acute angle with the surface of the roller bed 70.

Roller Bed

As described above, the feeder 40 serially feeds pieces of mail from the feeding station 20 to the roller bed 70. After a piece is displaced to the roller bed, the system controller 15 shuts off the vacuum to the suction cup 43, thereby releasing the piece. The piece then falls onto the roller bed.

Referring now to FIGS. 1 and 3, the details of the roller bed 70 will be described in greater detail. The roller bed 70 comprises a plurality of horizontally disposed cylindrical rollers 72. The rollers 72 may be parallel to each other and perpendicular to the direction of travel so that the mail moves straight along the roller bed 70. However, preferably, the rollers are skewed so that the rollers drive the mail forwardly along the roller bed and laterally toward a rail 75. In this way, the skewed rollers 72 drive the mail against the rail 75 to justify an edge of the mail against the rail.

Each of the rollers 72 comprise a plurality of grooves 73 sized to receive O-rings. The O-rings have a higher coefficient of friction than the surface of the rollers, to provide an area of increased friction between the roller bed and the mail, thereby improving the justification of the mail. As mentioned previously, the mail rests front face up on the rollers. Therefore, as the rollers 72 rotate, the rollers move the mail forwardly.

The rollers are driven by a belt engaging the bottom of the rollers, which is driven by a motor controlled by the system controller. Preferably, the system controller 15 drives the motor at a constant speed that is matched to the maximum speed at which the feeder arm 44 is displaced from the feeding station 20 to the roller bed 70. Since the speed of the conveyor is constant, the system controller 15 controls the pitch of the mail or the gap between pieces by controlling the feeding of the pieces by the feeder 40.

Reading the Mailing Information

The roller bed 70 conveys the mail to the reader 80, which reads the mailing information on mail 5. More specifically, the reader 80 scans the mail looking for printed information. In the preferred mode of operation, the reader 80 scans each piece to determine the recipient address printed on each piece. This can be done in one of several ways. First, as described further below, preferably, the reader 80 scans each piece, and then uses optical character recognition to read the address.

Alternatively, the reader 80 scans for a unique identification mark, such as a tracking number or a barcode, which uniquely identifies either the piece or the recipient of the piece. The system computer 16 then accesses a database that lists the recipient address for each identification mark. In this way, the apparatus can determine the address for a piece by simply scanning the identification mark for the piece.

The reader 80 comprises a high-speed line scan camera 82 mounted on an overhead arm, so that the camera faces downwardly. A conveyor belt 85 conveys the mail under the camera 82 with the mail front face up so that the address and/or identification mark are visible. A pair of opposing lights 83 illuminate the mail under the camera 82. Since the roller bed 70 justifies the mail, the position at which the address and/or identification mark are located is fairly constant, so that the area in which the camera scans for the address and/or identification mark can be minimized.

Typically, it is desirable to mount the lights 83 so that the lights are as close as possible to perpendicular to the scanning surface (i.e. the face of the piece of mail). This provides the maximum illumination, however, it may create undesirable reflection. Accordingly, it is desirable to mount the lights at a relatively low angle of incidence to minimize the reflection of lights off the piece. More specifically, preferably the lights are positioned so that the angle of incidence is approximately 30 degrees.

The camera 82 is a high resolution line scan camera, which is preferably suitable to achieve a 200×200 dpi image resolution. The acquisition rate of the camera is matched to the system transport speed so that a 200×200 dpi image resolution is achieved. The imaging camera 82 scans the pieces of mail and acquires data representing the light intensity at discrete points of each piece of mail. For each point, or pixel, the light intensity is represented by a gray scale number ranging from zero for black to 255 for white. The light intensity for each pixel is communicated to the computer as an eight bit representation corresponding to the gray scale number.

The gray scale data is preferably transferred to the system computer 16 and binarized to create a black and white representation of the image. By binarizing the data, the data for each pixel is converted from an eight bit gray scale representation to a one bit black or white representation, which significantly reduces the amount of image data. In addition, binarizing the image data operates to highlight the textual portions of the image, which is advantageous for further processing of the image data.

To binarize an image, the gray scale data for each pixel of the image is compared with a threshold. If the gray scale number for a pixel is above the threshold, the gray scale is converted to white. Conversely, if the gray scale number is below the threshold, the gray scale is converted to black.

The binarized data may then be analyzed to determine the presence of particular characteristics. For instance, the data may be analyzed to detect an identification mark in the form of a barcode, such as a Postnet barcode, which is then decoded to determine the corresponding recipient's address. Alternatively, and preferably, the data is analyzed using multiple line optical character reader (“MLOCR”) in an attempt to identify and read the address on the piece of mail or an alphanumeric identification code. The system computer 16 may perform the MLOCR analysis, however, preferably a separate computer is provided for performing the MLOCR analysis. Further, a single MLOCR program may be utilized, however, in the present instance a plurality of different MLOCR programs are utilized to analyze the data. Each MLOCR program processes the image data differently so that it is more likely that an address will be read using a variety of MLOCR programs rather than a single program. This reduces the rejection rate, since a piece is rejected if the apparatus cannot read the address or identification mark on the piece.

When using MLOCR to read the printed address, the scanned address may be compared against a database to ensure that the scanned mailing information is correct. For instance, the scanned address can be analyzed to determine whether the zipcode is correct. More specifically, the computer may have access to a database of zipcodes, and the address or addresses that correspond to each particular zipcode. The computer can analyze the address to ensure that the scanned street, city and state correlate to the scanned zipcode. If the scanned zipcode does not match the zipcode in the database that corresponds to the scanned street address, city and state, the piece is electronically tagged and processed separately, preferably by rejecting the piece and sorting it into a reject bin in the stacker 110. In other words, if a piece of scanned mailing information conflicts with the anticipated value for the piece of mailing information, the piece is rejected.

An example of the verification of the mailing information is as follows. A piece of mail is printed with the address: John Doe, 1500 Market Street, Philadelphia, Pa. 91103. The zipcode in the database shows that the zipcodes in Philadelphia start with 19 rather not 91. Therefore, the computer determines that an element of the scanned mailing information is incorrect for the piece, and the piece is rejected.

The apparatus may utilize a zipcode assignment module that may include a zip code assignment module to verify the addresses. The zipcode assignment module includes a program designed to analyze address information to determine whether the address information correlates to an actual postal address. To this end, the zipcode assignment module includes a database of valid postal addresses. In the present instance, the zipcode assignment module is linked with an MLOCR, which analyzes the image data that was scanned for a mail piece.

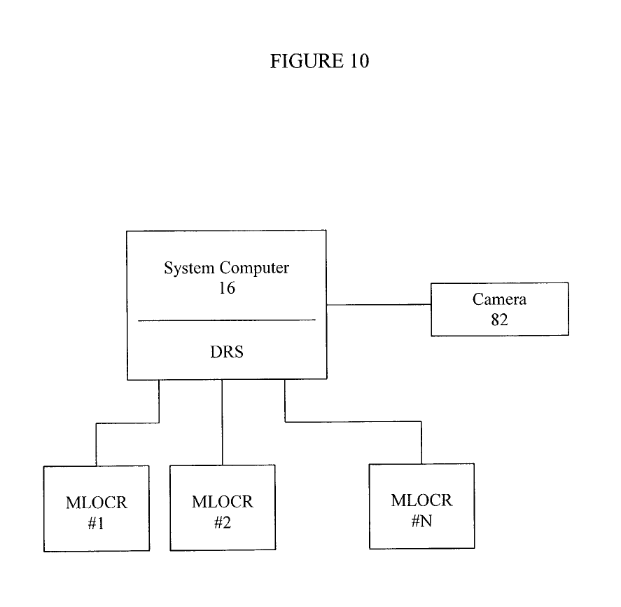

Referring to FIG. 10, preferably, the system computer 16 is linked with the camera 82 so that the scanned image data is transferred to the system computer, which processes the imaging data, such as by binarizing the data as described above. Preferably, the system computer is linked with several MLOCR engines that process the image data to produce sets of character data corresponding to the characters in the scanned mailing address. The sets of data are communicated to the zipcode assignment module, which analyzes the character data as discussed below. The zipcode module may be in the system computer, or in a separate computer. Similarly, the MLOCRs may each be in a separate computer, or they may be together in the same computer.

After analyzing the image data for a piece of mail, the system computer sends a signal to the system controller regarding the results of the analysis for further processing of the piece of mail. For instance, if the system computer is not able to identify a valid address based on the image data, the system computer indicates that the address for the mail piece is indeterminate and the system controller electronically tags the piece as unvalidated so that the piece is rejected. Similarly, if the address is determined, the system computer may communicate information regarding the mailing address for the piece, such as a 5-digit or delivery point zipcode for the piece. Subsequently, the zipcode may be converted into a barcode, such as a POSTNET barcode, which, in turn, may be applied to the mail piece.

The zipcode assignment module operates as follows: the zipcode assignment module receives the data from an MLOCR, compares the MLOCR data with the address information in the zipcode assignment module database and determines whether the MLOCR data represents a valid address. If the MLOCR data is not an exact match with an address in the zipcode assignment module database, the zipcode assignment module may make the best guess. For instance, if the MLOCR data identifies an address as 100 Pine Street and there is no Pine Street, but there is a Pine Avenue, the zipcode assignment module may make a best guess that the address is 100 Pine Avenue.

The zipcode assignment module may also identify additional information for an address. For instance, most mailing addresses have an extended 11-digit zipcode. The extended zipcode, also referred to as the delivery point barcode, is normally helpful in subsequent processing of the mail by the Postal Service. However, frequently an address is printed without the extended zipcode. Based on the street, city and state information in the address, the zipcode assignment module can identify the extended zipcode for the address on a mail piece. Further, based on the address information, the zipcode assignment module can also identify the POSTNET barcode representing the address. The POSTNET barcode can then be applied to the piece of mail, so that during subsequent processing the extended zipcode can be identified by simply reading the barcode.

As mentioned above, the device may include a plurality of MLOCRs to read the image data for a piece of mail. By using several MLOCRs, the device is more likely to read the address. The MLOCRs may be linked to a plurality of zipcode assignment modules such that each MLOCR is linked to a separate zipcode assignment module. However, preferably all of the MLOCRs are linked to a single zipcode assignment module.

When the MLOCRs are linked to a single zipcode assignment module, the MLOCR data may be processed in one of a number of ways. For instance, the zipcode assignment module may serially analyze the sets of data from the MLOCRs until an acceptable result is returned. Specifically, the zipcode assignment module may receive a first set of data from one of the MLOCRs. The first set of data to be analyzed may be selected according to various criteria, however, preferably the first set of data analyzed is selected based upon which MLOCR returns a result first (i.e. the zipcode assignment module first analyzes the data from the first MLOCR to finish processing the image data). Alternatively, based on certain criteria, one of the MLOCRs may be a preferred MLOCR so that the data from the preferred MLOCR is analyzed first.

If the first set of MLOCR data is consistent with an address in the zipcode assignment module database, then the address may be identified as a valid address, and the piece of mail may be electronically tagged as being validated for subsequent processing. In addition, the piece may be electronically tagged with additional mailing information, such as the appropriate POSTNET barcode information so that the information can be applied to the mail piece.

If the zipcode assignment module is unable to identify an address corresponding to the first set of MLOCR data, then the zipcode assignment module may analyze the data from a second MLOCR. In this way, the zipcode assignment module can serially analyze the sets of data from the MLOCRs until the address is validated. If the zipcode assignment module can not identify an address corresponding to any of the sets of MLOCR data the piece of mail is electronically tagged as not being validated so that the piece is outsorted into a reject bin.

Similarly, the zipcode assignment module may serially analyze the sets of data from the MLOCRs until the zipcode assignment module is able to identify an address corresponding to the address with a certain confidence level. More specifically, as discussed previously, if the zipcode assignment module does not identify an address that exactly matches the data from an MLOCR, the zipcode assignment module may make a best guess. The confidence that the MLOCR data corresponds to an address can be quantified as a confidence rating based on the number of differences between the MLOCR data and the data in the zipcode assignment module database. The more differences, the lower the confidence rating; the more significant the differences between the MLOCR data and the zipcode assignment module data, the lower the confidence rating.

For example, if the confidence rating is on a scale of 0 to 100, an exact match between the MLOCR data and the zipcode assignment module data would be a confidence rating of 100. If the MLOCR data indicated an address of 100 Pine Ave., Philadelphia, Pa. 19103 and the zipcode assignment module data indicated an address of 100 Pine St., Philadelphia, Pa. 19103, the confidence rating would be lower, but not significantly, such as 95. In contrast, if the MLOCR indicated that the address is 100 Pine St., Philadelphia, Pa. 19108 and the zipcode assignment module data indicates that 100 Pine St. in Philadelphia has a zipcode of 19103, not 19108, the confidence level may be lower because the zipcode is normally a significant element of an address, so that the confidence rating may be 85. The confidence rating may be even lower except that a three may be misread by an MLOCR as an eight if the three is blurred.

If the confidence rating for the result between the zipcode assignment module and the data from the first MLOCR is less than a pre-determined threshold, then the zipcode assignment module may determine that the set of data from the next MLOCR should be evaluated. In this way, the zipcode assignment module can serially analyze the sets of data from the MLOCRs until the zipcode assignment module determines that a set of data from one of the MLOCRs matches an address in the zipcode assignment module database with a certain confidence level. If the zipcode assignment module cannot identify an address corresponding to any of the sets of MLOCR data with a confidence level that meets or exceeds a predetermined threshold, then the piece of mail is electronically tagged as not being validated so that the piece is outsorted into a reject bin.

Alternatively, the zipcode assignment module may not validate an address unless the addresses from two MLOCR data sets match. Specifically, the zipcode assignment module may analyze the data set from a first MLOCR and identify an address corresponding to the MLOCR data, and having a confidence level above a pre-determined threshold. The zipcode assignment module may then analyze the data set from a second MLOCR. If the zipcode assignment module identifies an address for the second set of MLOCR data and the address matches the first address determined for the first set of MLOCR data, then the zipcode assignment module may determine that the correct address has been identified for the mail piece. Conversely, if the address for the second set of MLOCR data does not match the first data, the zipcode assignment module may then analyze the third data set. The zipcode assignment module may continue to analyze the MLOCR data sets until the addresses for two MLOCR data sets match with a certain confidence level.

Rather than serially analyze the sets of MLOCR data until an acceptable result is obtained, the zipcode assignment module may analyze each set of data and select the set of data with the best result. For instance, the zipcode assignment module may analyze each set of data and select the data producing an address match that has the highest confidence level. Similarly, the zipcode assignment module may analyze each set of data and only validate the address if the results from two sets of MLOCR data match the same address.

In the foregoing discussion, the zipcode assignment module evaluates the MLOCR data in sets depending on which MLOCR produced the data. However, in certain instances it may be desirable to pick and choose the data from the various data sets to identify an address. For example, one of the MLOCRs may do a good job reading the first line of the address, but may have difficulty reading the second line of the address; a second MLOCR may do a good job reading the second line of the address, but have difficulty reading the first line of the address. In order to validate the address, the zipcode assignment module may use the data from the first MLOCR regarding the first line of the address and the data from the second MLOCR regarding the second line of the address. The selected MLOCR data is then compared with the data in the zipcode assignment module database to determine if an address in the database matches the MLOCR data.

More specifically, the MLOCR data may include data reflecting the confidence that the character identified by the MLOCR is the same as the actual character that was scanned on the mail piece. The confidence that the character terrified by the MLOCR is the same as the actual character may be quantified as a confidence rating for the MLOCR data. The MLOCR data from the various MLOCRs can be selected based on the confidence rating.

For instance, when analyzing the image data for the character “S” in the address of a mail piece, a first MLOCR may identify the character as an “8” with a confidence rating of 80 on a scale of 0 to 255. A second MLOCR may identify the character as an “S” with a confidence rating of 225. Based on this comparison, the character would be identified as an“S” in the data used by the zipcode assignment module to identify the address. In this way, the data may be selected from the various MLOCR data sets on a character by character, word by word, or line by line basis.

After the image data is processed to determine the recipient's address for a piece of mail, the image data may be discarded. Alternatively, the image data may be exported and stored on a non-volatile medium such as a hard disk, CD or magnetic tape. The image for a piece can then be accessed later if necessary.

Weighing

After the mail is scanned, it is conveyed to a scale 90, which weighs each piece. A conveyor 92 on the scale conveys the mail as each piece is weighed. Specifically, a piece of mail exits the reader 80 and is conveyed onto the scale conveyor 92. As the scale conveyor 92 conveys the piece of mail forwardly, the scale 90 weighs the piece. The scale 90 is a precise scale, preferably able to accurately weigh the pieces to at least 1/10 of an ounce, at a rate of two pieces per second. To ensure the accuracy of the measurements, preferably a shield or guard 93 is placed over the scale 90, vertically separated from the conveyor 92. The shield 93 prevents debris from falling on the scale and reduces or eliminates the potential affect of downdrafts, which could alter the measured weight of a piece. After the scale determines the weight of a piece, the scale sends a signal to the computer 16 indicative of the weight.

After a piece of mail is weighed, the computer determines the proper postage to be applied to the piece at the labeling station 95. For some batches of mail, this determination can be made for each piece based simply on the weight of the piece. However, in the preferred mode, the postage determination for a piece of mail is made based on the weight of the piece and the address of the piece. Although the weight of the piece is known as soon as it is weighed, the address is not known as soon as the piece is scanned. It takes a certain amount of time to process the image data and read the address; and the amount of time it takes to do so varies depending on various characteristics, such as the clarity and font of the printing of the address.

Although the computer has time to process the image data and determine the address for a piece while the piece is being weighed, that time delay may not be sufficient to determine the address. Since in the preferred mode the postage label cannot be applied until the postage is determined, it may be necessary to buffer the piece while the computer determines the address, so that the computer can determine the proper postage. Several methods of efficiently buffering pieces while a computer reads the addresses are disclosed in co-pending U.S. application Ser. No. 09/816,687 filed Mar. 23, 2001, which is hereby incorporated herein by reference. One of the methods disclosed in application Ser. No. 09/816,687 can be incorporated into the present system between the reader 80 and the labeler 95.

In the preferred embodiment, the apparatus 10 includes a buffer conveyor 94 disposed between the scale 90 and the labeler 95. The buffer conveyor 94 is a straight conveyor that conveys the mail from the scale to the labeler. The time that it takes to convey a piece along the buffer conveyor 94 provides extra processing time, which may be necessary to read the address for the piece.

When the apparatus 10 is configured to include a buffer, it may be configured to accommodate operator intervention. Specifically, if the apparatus is unable to determine the mailing information after a pre-set time, it may be desirable to have an operator read the mailing information and manually key the information into the system. This allows unreadable pieces to be processed on-the-fly without being rejected.

To accomplish this, a computer screen and keyboard are provided for an operator. If the apparatus is unable to read a piece of mail, the scanned image of the piece is displayed on the output screen. The operator then reads the mailing information from the displayed image and keys in the necessary information. The operator's computer may be the system computer 16 or a separate computer linked to the system computer so that the keyed information is communicated with the system computer for use during subsequent processing of the piece.

Labeler

The labeler 95 applies labels onto the mail. The labeler 95 has a printer 97, so that it can print information on the labels before applying the labels to the mail. If the computer determines the proper postage to be applied to a piece, the printer 97 prints a label having the proper postage and the labeler then applies the postage label to the piece as the piece of mail is conveyed under the labeler. As at the scale 90 and the reader 80, the piece passes under the labeler in a horizontal disposition with the front face up. The term postage as used herein includes any form of appropriate postage that may be applied to a piece of mail. For instance, the postage may be a monetary amount as is typically printed by metered postage machines. Alternatively, and preferably, the postage is a postage permit that is printed on the label.

The labeler 95 comprises a vertically displaceable vacuum pad. The printer 95 prints a label, which is adhered to a typical backing paper. The label is peeled off the backing paper by a knife edge adjacent the vacuum pad. As the label is peeled off, a vacuum force applied to the vacuum pad sucks the label onto the vacuum pad. An arm attached to the vacuum pad then displaces the vacuum pad downwardly toward the piece of mail. Preferably, the vacuum pad does not touch the piece of mail. Instead the vacuum pad is maintained above the mail so that there is a gap between the label and the mail piece after the vacuum pad is displaced downwardly. To apply the label, the vacuum force applied to the vacuum pad changes to positive air pressure, which blows the label off the pad and onto the piece of mail.

The system controller 15 controls the operation of the labeler so that the labels are applied to the mail at the proper position along the length of the pieces. This is accomplished by controlling the timing at which the label is applied to a mail piece. Specifically, the system transport conveys the piece of mail to the labeler at a known constant speed. In addition, a sensor adjacent the labeler senses the leading edge of the piece of mail and sends a signal to the system controller. Since the distance from the labeler entry sensor to the label application point is known, and the transport speed of the piece being conveyed to the label application point is constant, the system controller can determine the appropriate time to apply the label, depending upon what point along the length of the mail piece the label should be applied.

The timing for applying the labeling can be fixed for a job so that the labels are applied a certain distance from the leading edge for each piece. Alternatively, the determination can be made on a piece by piece basis. For instance, in certain applications, it may be desirable to apply blank labels rather than postage labels. For example, it may be desirable to cover up markings on a mail piece or it may be desirable to provide a clear zone area, which is an area that should be free of printing under certain postal regulations. By analyzing the image data for a mail piece, the imaging computer may identify where along the length of the piece the blank label should be applied. The system controller then controls the labeler 95 so that the label is properly applied in response to the position determined by the imaging computer.

Further, although the labeler 95 is illustrated with manual adjustment for varying the placement of the labels along the height of the envelopes, it may be desirable to provide an automatically controlled drive motor for driving the labeler laterally across the width of the system transport. In this way the lateral position of the label application process can be varied on a piece by piece basis similar to the above basis for applying labels along the length of the pieces. Specifically, the imaging computer analyzes the image data for a piece to determine the appropriate position along the height of the piece for applying the label. The system controller 15 then controls the motor which drives the labeler 95 laterally to the proper position to apply a label on the piece. This can be combined with the piece by piece length determination to control both the lateral position of the labeler and the timing for applying the label to apply a label on substantially any desired location on the mail, on a piece by piece basis.

In the above example, the blank labels are used to cover up areas on the pieces of mail. In addition, blank labels can be used to increase the through rate for the apparatus. Specifically, labeler 95 utilizes thermal printing, which is typically slower than inkjet protect. Accordingly, a separate inkjet printer can be provided for printing the postage on the labels. In such a configuration, the labeler 95 applies a blank label to the envelope, and the inkjet printer then prints the postage on the applied label.

In addition to printing postage on the label, preferably the printer 97 prints additional information on the label that corresponds to the piece of mail. Specifically, the printer may print any or all of the following information on the label: the Postnet barcode that corresponds to the scanned address, the scanned zipcode, the extended 11 digit zipcode corresponding to the scanned address, the date the piece is processed, a unique tracking number for tracking the piece, the method of delivery (e.g. 1^{st} class, standard mail, etc.), and the weight of the piece.

If the computer does not determine the proper postage for an envelope prior to the pre-determined time necessary to print and apply a label, a postage label is not applied. The piece may be outsorted without a label, however, preferably a label is printed with a unique code and applied to the piece for use during reject processing. The system controller 15 and computer 16 then electronically tag the piece to correlate the image data and the unique code for the piece. The piece is then sorted separately from the mail for which the addresses were determined. For instance, if the address for a piece of mail cannot be determined using OCR, the image for the piece may be exported, and then, using local or remote video encoding, an operator can manually key in the address, which is then correlated with the unique code number associated with the piece. During subsequent processing, the address is determined simply by scanning the unique code. Co-pending U.S. application Ser. No. 09/816,687 filed Mar. 23, 2001 describes the details of such a system for printing a unique code on a piece, or applying a label with a unique code onto the piece, if the address on the piece cannot be determined.

Verifier

From the labeler 95, the pieces are conveyed to a stacker 110 where the mail is discharged into one of a plurality of bins. However, before discharging the mail, it may be desirable to scan the finished pieces to ensure that the labels were properly printed and applied. Accordingly, optionally the device includes a verifier 100 for verifying the mail. In the present instance, the verifier 100 is configured substantially similar to the reader 80, using a line scan camera 102 to scan the pieces as they are conveyed along a conveyor 105. The verifier 100 scans the pieces to ensure that the postage labels are correct, and then may discard the image data. Alternatively, the images for the pieces may be exported and stored on a non-volatile medium such as a hard disk, CD or magnetic tape. The image for a piece can then be accessed later if desired. In this way, an image of the piece as it appears right before being mailed can be stored in case a problem occurs during shipping (i.e. the piece gets lost in the mail). When the image data is exported, the image data for a piece includes the image data for the address and applied label of the piece.

Stacker

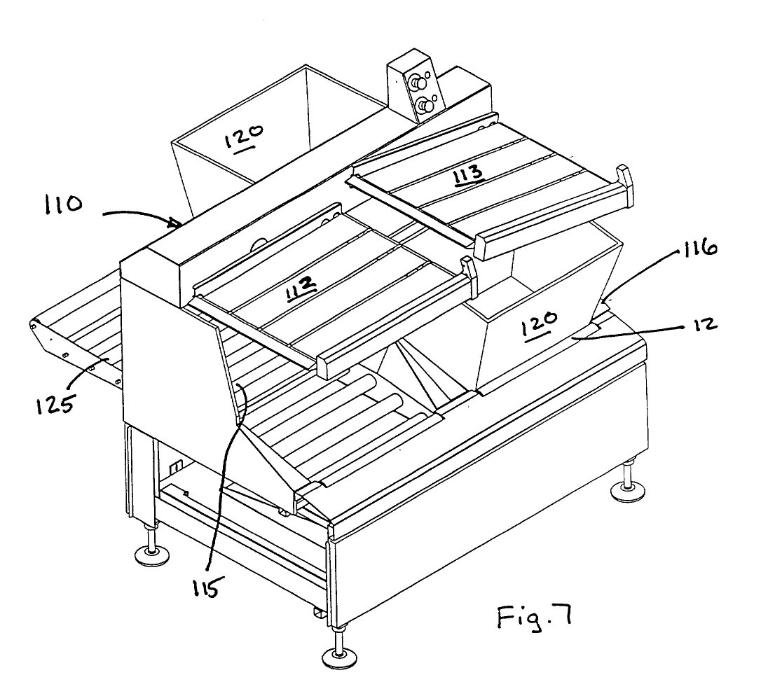

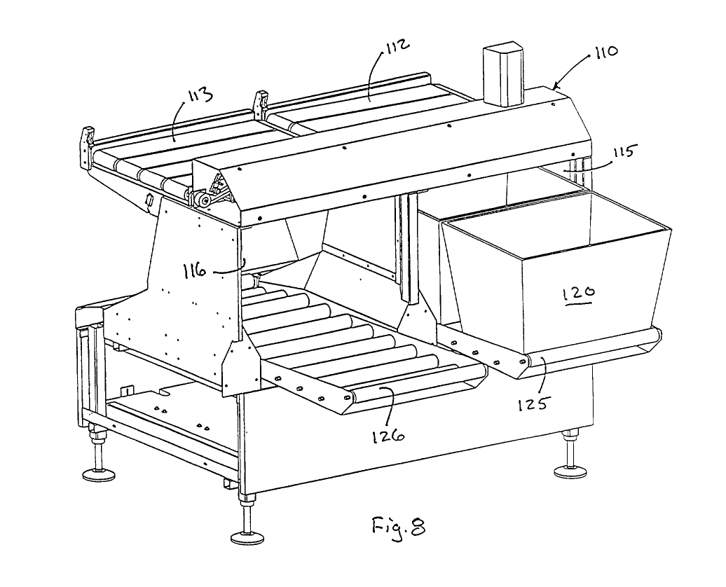

Referring now to FIGS. 1, 7 and 8, the details of the stacker are described in greater detail. The processed mail is discharged to the stacker 110. The stacker 110 may include a number of bins for receiving mail, however, in the present instance, the apparatus 10 is illustrated with a single stacker section, which includes two bins 115,116. A standard Postal Service tub 120 for receiving mail is typically disposed in each bin 115,116. However, to illustrate certain details of the stacker more clearly, in FIGS. 1 and 7 the second bin 116 is illustrated without a tub and in FIG. 8 the first bin is illustrated without a tub.

A pair of pivotable stacker conveyors 112,113 are disposed over the stacker bins 115,116. When a piece of mail is to be discharged into a tub 120 in a particular bin, the conveyor over top the bin pivots upwardly before the piece reaches the bin, as shown in FIG. 7, and discussed further below.

In the bottom of each bin is a roller track 125,126 that form discharge tracks for the tubs 120. As shown in FIG. 8, the discharge tracks 125,126 extend rearwardly through an opening in the back of the stacker 110, so that each track can accommodate a plurality of tubs. More specifically, the track within each bin 115, 116 is sufficient to accommodate two tubs, and preferably an extension or support is attached to the back end of the stacker to elongate each track. In this way, the tracks are long enough to accommodate three tubs. Therefore, when the first tub in a bin is full, it can be pushed to the back by inserting an empty tub into the bin. This can be done without interrupting the flow because any mail sorted to the bin while the full tub is being pushed out will either fall into the empty tub or into the full tub, since the empty tub is being used to push back the full tub.

After a full tub is pushed to the end of the discharge track transverse the flow of mail, it is out of the flow of mail being sorted, and can be easily removed by the operator. In addition, although the discharge tracks 125,126 are illustrated as being approximately as long as the width of three standard Postal Service mail tubs, it may be desirable to elongate the tracks further to accommodate more tubs. Alternatively in certain applications, it may not be necessary to extend the track beyond the back of the stacker 110. FIG. 2 illustrates such a configuration in which there is no support extending the track from the back of the stacker. In such instances, each bin is preferably configured to accommodate two tubs.

When using only one stacker unit 110 with two bins, the mail may be sorted in a simplified manner. For instance, mail that has postage applied during processing may be discharged into the tub 120 in the first bin 115. Any rejects, such as mail for which the address was not determined, may be discharged into a tub in the second bin 116.

For more sophisticated sorting, additional stacker units can be added to the end of the stacker 110, so that the stacker units are lined up in a row. When additional stacker units are used, the mail can be sorted according to various criteria. For instance, the mail may be sorted according to zipcode or weight, or a combination of such features.

The stacker operates as follows. The system controller 15 determines which bin a piece of mail is to be sorted into based on the characteristics of the piece of mail determined during processing, and the predetermined sort criteria. For example, returning to the two bin sorting example mentioned above, suppose that mail having postage applied is sorted into the first bin 115 and rejects are sorted into the second bin 116. If postage is applied to a piece during processing, the system controller 15 determines that the piece should be sorted into the first bin 115. As the piece approaches the first stacker conveyor 125, the leading end of the conveyor pivots upwardly. (From the perspective of FIG. 1, the leading end is the left-most end.) After the conveyor 125 pivots upwardly, the piece is conveyed from the verifier transport into the first bin 115. The stacker conveyor 125 then pivots back down into a horizontal disposition.

Continuing with this example, if the address for the piece is not determined, the system controller 15 may tag the piece as a reject, and determine that it is to be discharged into the second bin 116. Such a piece is conveyed from the verifier conveyor onto the first stacker conveyor 125 over the first bin 115. The piece rides on top of the first stacker conveyor 125, which conveys the piece toward the second stacker conveyor 126. Before the piece reaches the second stacker conveyor 126, the leading end of the second stacker conveyor pivots upwardly, an shown in FIG. 7, so that the piece falls into a tub in the second bin 116.

There is a gap between adjacent stacker conveyor sections, which allows the sections to pivot readily. However, the gap is small enough so that, if the second stacker conveyor remains horizontal, a piece of mail exiting the first stacker conveyor will be placed on the second stacker conveyor 126, which in turn will convey it toward a third stacker conveyor. In this matter, the mail can be transported along the stacker conveyors in the stacker sections to the appropriate bin when a number of stacker sections are utilized.

As described above, a tub 120 is manually pushed out of a bin by an operator when the tub is full. Alternatively, the apparatus may be configured to automatically discharge a full tub and replace it with an empty tub. Specifically, the tracks 125, 126 may be configured so that an empty tub fits on the track in front of each of the tubs that are positioned to receive mail pieces.

In the alternate arrangement, the tracks 125, 126 are angled downwardly from front to back so that the tubs tend to roll rearwardly to be discharged. A stop, such as a stop block attached to a solenoid, operates to hold the tubs in position to receive the mail. A sensor in each bin monitors the tubs to determine whether a tub is full. When a bin sensor senses that a tub is full, the sensor sends a signal to the system controller indicating that the tub is full. The system controller then actuates the solenoid to displace the stop block inwardly so that the stop block releases the tub.

When the full tub is released it slides down the discharge track to the back of the stacker since the track is angled downwardly toward the back. At the same time, the empty tub at the front of the bin slides down the track into position to receive mail. A separate sensor detects the full tub as it is being discharged. After the sensor detects the trailing edge of the tub, the system controller 15 actuates the solenoid, which displaces the stop block outwardly to stop the empty tub in position to receive mail.

Accommodating Varied Mail

The apparatus 10 is operable to accommodate mail having varied characteristics, such as mail of thicknesses, and mail in different types of envelopes. In its standard mode, the reader camera 82, labeler 95 and verifier camera 92 are disposed at a set height above the system transport to accommodate standard mail having a thickness of approximately 1¼ inches or less. At this height, the focal plane and depth of field of the cameras 82, 102 is sufficient to focus on the typical mail being processed, and the labeler is properly positioned to apply labels to such mail.

For thicker mail, the cameras 82, 102 and the labeler 95 can be vertically adjusted. Specifically, the cameras 82, 102 are mounted on horizontal arms of stands 87,107. The horizontal arms are vertically adjustable to adjust the focal plane of the cameras upwardly so that the cameras can focus on the front face of the thicker mail. The labeler is mounted on a vertically adjustable arm. Turning a handwheel 98 adjusts the height of the labeler relative to the system transport. To process the thicker mail, the thick pieces are processed as a separate batch. Prior to processing the batch, the cameras 82, 102 and labeler 95 are adjusted to the proper height. Although the adjustments are described as manual adjustments, motors may be provided for automatically adjusting the vertical positions of the cameras and the labeler. In such a configuration, the operator would input into the system computer the desired height, and the system controller drives the motors to adjust the cameras and labeler to the desired height.

Alternatively, the apparatus can be modified to process mail regardless of the thickness of the pieces, without adjusting the cameras 82, 102 or the labeler 95. Specifically, the cameras 82, 102 and labeler 95 can be positioned below the transport path. The mail is then transported front face down so that the reader 80 and verifier 100 can scan the mail, and the labeler can apply the postage labels to the front face of the mail. By positioning the cameras 82, 102 and the labeler 95 below the transport path, the front face of each piece of mail is a fixed distance from the cameras and the labeler regardless of the thicknesses of the pieces. To permit this upside-down scanning, a window, or gap, is provided in the system transport so that the reader 80 and verifier 100 can illuminate and scan the front faces of the mail pieces. Similarly, a gap or window in the system transport is provided adjacent the labeler to provide an access window for applying the postage labels onto the pieces of mail.

The apparatus 10 can also accommodate tall mail. For tall mail, the cameras 82, 102 do not necessarily need to be adjusted, since the mail is scanned lying front face up. However, it may be necessary to adjust the position of the printer laterally across the width of the system transport so that the labels are applied at the proper positioned along the length of the envelopes. Specifically, during processing, the mail pieces are placed into the feeding station 20 on their bottom edges. In this way, when the pieces are fed onto roller bed 70 and justified, the bottom edge of each piece is justified against rail 75. According to postal regulations, the postage is to be applied above and to the right of the address for a piece (typically the postage is applied to the upper right hand corner of an envelope). A standard No. 10 envelope is approximately 4 inches tall, so that the postage label is applied approximately 3 inches from the bottom edge. However, taller envelopes, such as some flats, are approximately nine inches tall, so that applying the postage label 3 inches from the bottom edges of the flats would improperly apply the postage label too close to the bottom edge.

The apparatus 10 can accommodate the different heights of mail in one of several ways. First, the tall mail can be separated out and run as a separate batch. Before processing the batch of mail, the labeler can be adjusted laterally across the path of the system transport by turning handwheel 99. In this way the position of the label relative to the bottom edge of the mail can be varied.

Alternatively, the mail can be placed into the feeding station on its top edge so that the top edge of the mail is justified against rail 75. The labeler 95 can then apply postage labels to all of the mail a certain distance from the justified top edge, regardless of the height of the mail.

Another alternative is to change the skew of the rollers so that the mail is justified against a rail at the back of the roller bed rather than the front of the roller bed as shown in FIG. 4. In such an arrangement, the mail is placed in the feeding station on its bottom edge, as previously described, and then fed onto the roller bed. The roller bed then justifies the mail toward the back rail so that the pieces are top edge justified. As in the previous alternative, if the mail is top-edge justified, the labeler 95 can properly apply postage labels without being adjusted, regardless of the height of pieces.

In addition to handling mail of different thicknesses and different heights, the apparatus can handle mail of different orientations, such as landscape and portrait types of envelopes. A landscape type of envelope is the typical envelope in which the top and bottom edges of the envelope are longer than the side edges. Portrait envelopes are ones in which the side edges are longer than the top and bottom edges.

Typical mail is ordinarily landscape mail, which is processed as described above. In contrast, portrait mail is preferably processed in a different matter, so that it is processed as a separate batch. The batch of portrait mail may be placed in the feeding station bottom edge down. However, since portrait mail is taller than it is long, portrait mail is somewhat unstable when it is upright, and it can be awkward to process in this matter. Accordingly, preferably the batch of portrait mail is rotated 90 degrees and placed in the feeding station side edge down. In this orientation, the printed mailing information is transverse the direction of mail flow, rather than parallel to the mail flow, as with landscape mail. Preferably the orientation of the mail is a job parameter that the operator can input into the system computer for the batch prior to processing. Therefore, when the reader 80 scans a piece, the computer knows the orientation of the characters for which it is searching during MLOCR or bar-code detection. This improves the rate at which the computer can read the mailing information.

In addition, the labeler is pivotable so that it can be pivoted 90 degrees to apply the postage label in the proper orientation. More specifically, the labeler is pivotally attached to an arm. The labeler can be pivoted 90 degrees and locked in the pivoted position so that the print on the postage labels is oriented correctly relative to the mailing information on the pieces (i.e. transverse the direction of the flow of mail along the system transport). All of the portrait mail is loaded into the feeder so that all of the pieces are on the same edge—either the right side edge or the left side edge. If the pieces are fed on their left edge, the actual top right corner of the pieces is located in the upper left-hand corner relative to the landscape perspective. Conversely, if the mail rests on its right side edge, the actual top right hand corner of the pieces will be located in the lower right hand corner relative to the landscape perspective. Therefore, if the mail rests on its right side edge, the labeler 95 is manually adjusted laterally by turning handwheel 99 so that the labeler is positioned to apply the labels to the mail adjacent the leading edge toward the front edge of the apparatus. Conversely, if the mail is fed into the feeding station on its left-hand side, the labeler is displaced laterally across the transport path so that the label is applied to the edge of the mail away from the front of the apparatus. In addition, the system controller 15 controls the timing of applying the label so that the label is applied along the piece near its trailing edge, which is actually the top edge of the piece.

In other words, when the profile pieces are rotated into a landscape orientation, the labeler applies the labels onto the pieces in either the upper left-hand corner or the lower right-hand corner from the landscape perspective. Which of these two locations depends on which side the pieces are placed into the feeding station 20.

In certain applications, it may be desirable to process portrait mail upright in the portrait orientation, rather than turning the portrait pieces sideways and processing them in a landscape orientation. However, if the pieces are processed in portrait orientation, the pieces may not properly fit within the tubs in the stacker 110. Therefore, the apparatus may include a rotation mechanism disposed between the verifier 100 and the stacker 110. The rotation mechanism operates to rotate the mail pieces approximately 90 degrees from a portrait orientation into a landscape orientation so that the pieces can be stacked properly in the stacker tubs.

Verification Mode

In addition to the foregoing methods of operation, the apparatus is operable in a verification mode. In this mode, information about each piece in a batch of mail is known before the batch is processed. For instance, in certain instances, information about the pieces in a batch of mail may be previously determined during processing of the batch by a previous pass through the apparatus, or by processing using a different apparatus or by manual processing. In one example, a batch of mail is processed through the apparatus during a first pass, in which each piece is scanned, the address is determined, the weight is determined, postage is applied, and a unique identifier is printed and applied. This information is compiled into a database during the first pass so that the information is available during subsequent processing in the verification mode.

During the verification mode, the pieces are serially fed and scanned by the reader 80. The reader 80 uses MLOCR as previously described to determine the address for each piece. Alternatively, if an identifier, such as a barcode or identification number is printed on the pieces, the reader 80 may simply scan for an identifier on each piece. Once the reader reads the identifier for a piece, the system computer 16 can access the data for the piece in the database.

Similarly, the verifier 100 may scan the pieces to simply look for an identifier on the pieces. The identifier on the pieces may be printed on the postage label during an earlier pass through the apparatus. For such mail, the image data for the entire front face need not be analyzed to locate and identify the identification mark. Specifically, the apparatus would have placed the postage label in the upper right-hand corner on the piece during the first pass. Therefore, during the verification pass, the image data for the upper right-hand corner can be analyzed to locate the identification mark. In addition, since the piece may processed in a different orientation during the verification pass than the first pass, the label may be in a different corner of the scanned image. Therefore, the image data for two or more corners may be analyzed to identify the identification mark. However, regardless of whether one corner or for corners are checked, the processing time to find the identification mark is significantly reduced since only certain portions of the image data is analyzed for a piece rather than all of the image data for the piece.

After the piece is scanned, it is weighed on the scale 90. The system computer 16 compares this weight with the weight for the piece in the database. If the two weights do not match (within a pre-determined tolerance) the piece is electronically tagged and rejected. In this way, the apparatus can verify each piece against the pre-determined information for the pieces.

One advantage of checking the weight in the verification mode is that double feeds can be readily detected. If the weight determined during the verification mode is significantly higher than the anticipated weight for a piece it is likely that the piece is actually two pieces that the feeder 40 erroneously fed together so that they pass under the reader on top of one another. Since the weight for such a double feed will be significantly higher than the anticipated weight for the lead piece (i.e. the piece on top), the apparatus assumes that the scanned piece is not a single piece of mail, and the scanned piece, along with the piece or pieces under it, are outsorted to a reject bin.

If the weight of the piece properly correlates to the anticipated weight, the piece is conveyed to the stacker 110 and sorted based on its address and/or weight. During the verification mode, it is typically unnecessary to print and apply a label onto the pieces. However, a proper postage label may be printed and applied to a piece during the verification mode, if desired.

In addition, during the verification mode, the apparatus can monitor the mail to ensure that each piece in a batch is accounted for during processing. For instance, if the database for a batch indicates that the batch includes 100 pieces, and during the verification mode the apparatus indicates that only 98 pieces were processed, then the apparatus indicates that two pieces are unaccounted for. Further, since the apparatus identifies the pieces during the verification mode, the system computer can determine which pieces in a batch were identified, and which were not. In this way, the exact pieces which are unaccounted can be identified. Similarly, if the apparatus indicates that 100 pieces were processed and 98 pieces were properly identified and sorted in the stacker and two pieces were rejected, then the system computer 16 indicates that two pieces were not identified, and the two pieces are presumably the pieces in the reject bin.

Blank Envelope Processing

In the foregoing discussion, the mail being processed is pre-printed with some type of mailing label. However, it may be desirable to process blank mail which is not yet addressed. The apparatus can be modified to process such mail.

To process blank mail, such as blank envelopes containing documents, a separate labeler for printing address labels is added to the apparatus, and preferably positioned before the scale 90. The address labeler may be configured similarly to the postage labeler, however it would be configured to print and apply address labels rather than postage. Although an address labeler is preferable, it may be possible to simply use the printer, such as an inkjet printer, to print the addresses directly onto the pieces. Since the addresses are printed and applied to the pieces, the apparatus knows the mailing information for the pieces without scanning them. Therefore, the reader could be eliminated if desired.

Accordingly, processing blank envelopes proceeds as follows. A stack of blank envelopes containing contents, such as bulk mailing documents, are placed into the feeding station. The pieces are serially fed to the address labeler. The address labeler prints an address for each piece based on information stored in a database accessible by the system computer. The labels are applied to the pieces, which are then weighed. The appropriate postage is applied to each piece by the labeler 95 based on the weight of each piece and the recipient's address. The piece is then scanned by the verifier 100 and sorted in the stacker 110.

When processing blank envelopes, often the weight of the pieces is constant. Therefore, if the weight of a piece is outside of an expected range, the piece may actually be two pieces that were doubled fed. Such pieces are electrically tagged and outsorted to a reject bin in the stacker 110.

The terms and expressions which have been employed are used as terms of description and not of limitation. There is no intention in use of such terms and expressions of excluding any equivalents of the features shown and described or portions thereof. It is recognized, however, that various modifications of the embodiments described herein are possible within the scope and spirit of the invention. For instance, the feeder has been described as using a pivoting and translating feeder 40. However, in certain instances, such as when all of the intended mail is to be standard envelopes, a different feeder may be utilized. One example is a belt-type feeder, such as the feeder disclosed in U.S. Pat. No. 5,926,392 which is incorporated herein by reference. Further, it may be desirable to maintain the documents on edge in certain applications, such as when the intended mail simply comprises standard letter-sized envelopes or similar envelopes. In such applications the use of a roller bed may be eliminated. Accordingly, the invention incorporates variations that fall within the scope of the following claims.

1. A method for processing pieces of mail to identify address information, comprising the steps of:
scanning mailing information on a piece of mail to obtain image data;
analyzing the image data using a first OCR module to obtain a first set of character data;
analyzing the image data using a second OCR module to obtain a second set of character data;
comparing the data from the first and second sets of character data;
selecting data from the first or second sets of character data in response to the step of comparing; and
analyzing the data selected during the step of selecting data to identify address information for the mail piece.

2. The method of claim 1 wherein the step of selecting data comprises selecting data from the first set of character data based on the step of comparing, and selecting data from the second set of character data based on the step of comparing.

3. The method of claim 1 wherein the steps of analyzing the image data using first and second OCR modules comprises assigning confidence data to the character data in the first and second sets, wherein the confidence data comprises a valuation of the likelihood that the character data is the same as the character in the mailing information on the piece of mail.

4. The method of claim 3 wherein the step of comparing comprises comparing the confidence data to determine which character set has higher confidence data for certain character data.

5. The method of claim 3 wherein the step of selecting data comprises selecting select character data from the character set that has the higher confidence data for the select character data.

6. The method of claim 1 comprising the step of applying information to the mail piece corresponding to the address information identified for the mail piece.

7. An apparatus for processing pieces of mail to identify address information, comprising:
a scanner for scanning mailing information on a piece of mail to obtain image data;
a first OCR module operable to analyze the image data to obtain a first set of character data;
a second OCR module operable to analyze the image data to obtain a second set of character data; and
an address processing module operable to select character data from the first and second character data sets, and analyze the select data to identify address information for the piece of mail.

8. The apparatus of claim 7 wherein the first and second OCR modules are operable to assign confidence data to the character data in the first and second sets, wherein the confidence data comprises a valuation of the likelihood that the character data is the same as the characters in the mailing information on the piece of mail.

9. The apparatus of claim 8 wherein the address processing module is operable to compare the confidence data associated with the character data to determine which character set has higher confidence data for certain character data.

10. The apparatus of claim 8 wherein the address processing module is operable to select the character data having the higher confidence data.

11. The apparatus of claim 7 comprising a printer for printing information corresponding to the address information identified for the mail piece.

12. An apparatus for processing pieces of mail having mailing information, comprising:
a scanner operable to scan a piece of mail to obtain image data corresponding to the mailing information for the piece;
a first OCR module operable to receive and process the image data to create a first set of character data for the piece of mail;
a second OCR module operable to receive and process the image data to create a second set of character data for the piece of mail;
an address processing module, comprising a database of address information, wherein the address processing module is in operative communication with the first and second OCR modules and is operable to receive and process the character data from the first and second character data sets and compare the character data with the address information in the database to identify address information corresponding to the mailing information on the piece of mail.

13. The apparatus of claim 12 wherein the scanner is a high speed line scan camera.

14. The apparatus of claim 12 wherein the scanner is operable to scan the piece of mail as the piece of mail is being conveyed along a transport path.

15. The apparatus of claim 12 comprising a printer for printing the identified address information.

16. The apparatus of claim 15 comprising a labeler for applying a label to the mail piece, wherein the printer prints the identified address information on the label.

17. The apparatus of claim 12 wherein the address processing module is operable to compare the first character data with the database and identify address information for the piece of mail, and the address processing module is operable to compare the second character data with the database and identify address information for the piece of mail.

18. The apparatus of claim 12 wherein the address processing module is operable to compare the first set of character data with the address information in the database to attempt to identify the address information corresponding to the mailing address for the piece, wherein if the address processing module is unable to identify the address information for the piece based upon the comparison of the first set of character data, the address processing module is operable to compare the second set of character data with the address information in the database to attempt to identify the address information corresponding to the mailing information for the piece.

19. The apparatus of claim 12 wherein the address processing module is operable to analyze the first set of character data to identify a first set of address information for the piece and the address processing module is operable to analyze the second set of character data to identify a second set of address information for the piece; wherein the address processing module is operable to select one of the first and second sets of address information to use for further processing of the piece.

20. The apparatus of claim 12 wherein the address processing module is operable to select data from the first and second sets of character data and compare the select data with the address information in the database to identify the address information corresponding to the mailing information for the piece.

21. The apparatus of claim 20 wherein the select data comprises less than all of the data in the first set of character data and less than all of the data in the second set of character data.

22. A method for processing pieces of mail to identify address information, comprising the steps of:
scanning address information on a piece of mail to obtain image data;
analyzing the image data using a first OCR module to obtain a first set of character data;
analyzing the image data using a second OCR module to obtain a second set of character data; and
processing the first and second character data sets using an address processing module having a database of address information, comprising the steps of:
communicating the character data from the first and second sets of character data with the address processing module;
comparing the character data with the address information in the database to identify address information corresponding to the mailing information on the piece of mail.

23. The method of claim 22 wherein the step of scanning comprises scanning the piece of mail with a high speed line scan camera.

24. The method of claim 22 where the step of scanning comprises scanning the piece of mail as the piece of mail is being conveyed along a transport path.

25. The method of claim 22 comprising the step of printing the identified address information.

26. The method of claim 25 comprising the step of applying a label to the mail piece, wherein the step of printing prints the identified address information on the label.

27. The method of claim 22 wherein the step of comparing comprises comparing the first set of character data with the database to identify address information for the piece of mail, and comparing the second set of character data with the database to identify address information for the piece of mail.

28. The method of claim 22 wherein the step of comparing comprises comparing the first set of character data with the address information in the database to attempt to identify the address information corresponding to the mailing address for the piece, wherein if the address information is not identified for the piece of mail based upon the comparison of the first set of character data, then the step of comparing further comprises comparing the second set of character data with the address information in the database to attempt to identify the address information corresponding to the mailing address for the piece.

29. The method of claim 22 wherein the step of comparing comprises the steps of:
comparing the first set of character data with the address information in the database to identify a first set of address information for the piece of mail;
comparing the second set of character data with the address information in the database to identify a second set of address information for the piece of mail; and
selecting one of the first and second sets of address information to use for further processing of the piece.

30. The method of claims 29 wherein the step of selecting comprises prioritizing the MLOCRs such that for each documents, the character data from the first MLOCR are used for further processing before the character data from the second MLOCR.

31. The method of claim 29 wherein the steps of analyzing the image data using the first and second OCRs comprises assigning confidence data to the first and second sets of character data;
wherein the confidence data comprises a valuation of the likelihood that the character data is the same as the character in the mailing information on the piece of mail;
wherein the step of selecting comprises selecting the character data based on the confidence data.

32. The method of claim 29 wherein the step of selecting comprises selecting the character data from the first of the two OCRs that first finishes analyzing the image data.

33. The method of claim 22 wherein the step of processing the first and second sets of character data comprises the step of selecting data from the first and second sets of character data, and the step of comparing comprises comparing the select data with the address information in the database.

34. The method of claim 33 wherein the step of selecting data comprises selecting less than all of the data in the first set of character data and selecting less than all of the data in the second set of character data.

35. The method of claim 34 wherein the step of selecting data comprises selecting some of the data in the first set of character data and selecting some of the data in the second set of character data.
